(19) United States
(12) Patent Application Publication
(10) Pub. No.: US 2003/0161067 A1
(43) Pub. Date: Aug. 28, 2003

(54) Determining head position during a head switch using multiple index codes

(75) Inventors: Nicolai Robert Ramler, Boulder, CO (US); Christopher Thomas Settje, Westminster, CO (US); Ewe Chye Tan, Longmont, CO (US); Khalil B. Dizaji, Louisville, CO (US)

Correspondence Address: MERCHANT & GOULD P.C., P.O. Box 2903, Minneapolis, MN, 55402-0903, US

(73) Assignee: Seagate Technlogy LLC

(21) Appl. No.: 10/179,153

(22) Filed: Jun. 24, 2002

Related U.S. Application Data
(60) Provisional application No. 60/361,194, filed on Feb. 27, 2002.

(51) Int. Cl. G11B 5/596; G11B 5/09; G11B 15/12

(52) U.S. Cl. 360/77.05; 360/51; 360/63

(57) ABSTRACT

An embodiment of the present invention may be described as a method of determining a disc drive head position over a data surface during a head switch operation. The method includes switching from a first head located over a first data surface on one disc to a second head located over a second data surface on a different disc. Each data surface has non-index servo sectors interspersed between a plurality of index servo sectors defined thereon, and each index servo sector has a unique index code corresponding to its angular track position. The method also includes reading an index code from an index servo sector on the second surface and determining an index servo sector number from the index code. Additionally, the method includes incrementing the servo sector number as the second head encounters subsequent servo sectors. A disc drive includes data storage discs arranged in a disc stack. The disc drive is adapted to ascertain head position following a head switch between a first head positioned over a first data surface on one disc and a second head positioned over a second data surface on a different disc utilizing a plurality of index servo sectors defined on the second data surface.

### RELATED APPLICATIONS

This application claims priority of U.S. provisional application Serial No. 60/361,194, filed Feb. 27, 2002.

### FIELD OF THE INVENTION

This application relates generally to disc drives and more particularly to determining head position in a disc drive during a head switch.

### BACKGROUND OF THE INVENTION

A typical disc drive includes a spindle motor, which rotates one or more discs at a constant high speed. Information is written to and read from circular tracks on the discs through the use of an actuator assembly that includes an actuator or head that flies in close proximity above the corresponding surface of the associated disc.

In disc drive utilizing a sector servo system, each track includes servo sectors that are separated by data sectors. Each servo sector includes a track identification code that can be unscrambled to determine a track number that uniquely identifies the track. Track identification codes are typically encoded in Gray code. Each servo sector typically also includes one bit that identifies an index location on the track. For example, one servo sector (the index servo sector) on each track can include a “1” in the index bit, while all other servo sectors include a “0” in the index bit. The index bit serves as the starting point for determining angular position of a head over a data surface on a disc. Once the index bit has been encountered, the disc drive includes a counter that increments each time another servo sector is encountered. Thus, the index servo sector is often servo sector number zero; the next servo sector encountered by the head is servo sector number one; etc.

Many disc drives utilize multiple discs, or at least two surfaces of a single disc. When the drive switches from reading one surface to reading another surface (i.e., a head switch), the disc drive typically either assumes that the index servo sectors of the two surfaces are angularly aligned or rotates the disc until the index servo sector is encountered before reading or writing data. The assumption that the index servo sectors are aligned may or may not be correct. For example, a consumer may jolt the disc drive, resulting in the index servo sectors on separate discs being circumferentially offset. If the disc drive design assumes that the index servo sectors will be aligned, then such misalignment may cause a failure of the disc drive. On the other hand, the disc drive could wait almost a complete disc revolution before the head encounters the index servo sector. Thus, if the disc drive waits for the head to encounter the index servo sector after each head switch undue delays will result.

Accordingly there is a need for a disc drive that can locate information on a track of a disc during a head switch without requiring a complete revolution of the disc and without assuming that the index servo sectors of multiple disc surfaces are aligned. The present invention provides a solution to this and other problems, and offers other advantages over the prior art.

### SUMMARY OF THE INVENTION

Against this backdrop the present invention has been developed. An embodiment of the present invention may be described as a method of determining a disc drive head position. The method includes switching from a first head to a second head. The method also includes reading an index code from a one of a plurality of index servo sectors on a second data surface and determining an index servo sector number from the index code. Additionally, the method includes incrementing the servo sector number as the second head encounters subsequent servo sectors.

An embodiment of the present invention may be alternatively described as a method of determining a disc drive head position over a data surface during a head switch operation. The method includes switching from a first head positioned over a first data surface on one disc to a second head positioned over a second data surface on a different disc. Each data surface preferably has non-index servo sectors interspersed between index servo sectors defined thereon. The index servo sectors include a main index servo sector on each data surface and a secondary index servo sector on each data surface. Each index servo sector has a unique index code corresponding to its angular track position, and the index servo sectors on the first data surface are angularly offset from the index servo sectors on the second data surface. The method also includes reading an index code from an index servo sector on the second surface, and determining a servo sector number from the index code. The method additionally includes incrementing the servo sector number as each subsequent servo sector is encountered by the second head, and resetting the servo sector number to a predetermined value when the second head encounters the main index code.

Yet another embodiment of the present invention may be described as a disc drive that includes data storage discs arranged in a disc stack. The disc drive is adapted to ascertain head position following a head switch between a first head positioned over a first data surface on one disc and a second head positioned over a second data surface on a different disc utilizing a plurality of index servo sectors defined on the second data surface.

These and various other features as well as advantages which characterize the present invention will be apparent from a reading of the following detailed description and a review of the associated drawings.

### BRIEF DESCRIPTION OF THE DRAWINGS

FIG. 1 is a plan view of a disc drive incorporating a preferred embodiment of the present invention showing the primary internal components.

FIG. 2 is a perspective diagrammatic view of a disc with markings indicating the positions of index servo sectors along a track on the disc, according to an embodiment of the present invention.

FIG. 3 is a broken away perspective diagrammatic view of the disc illustrated in FIG. 2, but additionally illustrating non-index servo sector positions.

FIG. 4 is a diagrammatic illustration of a servo sector according to an embodiment of the present invention.

FIG. 5 is a diagrammatic illustration of a cylinder number according to an embodiment of the present invention.

FIG. 6 is a diagrammatic illustration of a register structure according to an embodiment of the present invention.

FIG. 7 is a perspective diagrammatic view of two discs of a disc stack with markings indicating the positions of index servo sectors along a track on each data surface, according to an embodiment of the present invention.

FIG. 8 is an illustration of a process flow for locating the angular position of a head during a head switch operation.

### DETAILED DESCRIPTION

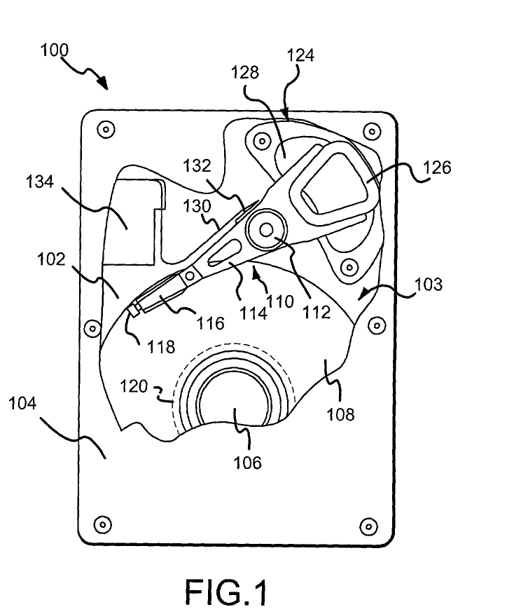

A disc drive 100 constructed in accordance with a preferred embodiment of the present invention is shown in FIG. 1. The disc drive 100 includes a base 102 to which various components of the disc drive 100 are mounted. A top cover 104, shown partially cut away, cooperates with the base 102 to form an internal, sealed environment for the disc drive in a conventional manner. The components include a spindle motor 106, which rotates one or more discs 108 at a constant high speed. Information is written to and read from tracks on the discs 108 through the use of an actuator assembly 110, which rotates during a seek operation about a bearing shaft assembly 112 positioned adjacent the discs 108. The actuator assembly 110 includes a plurality of actuator arms 114 which extend towards the discs 108, with one or more flexures 116 extending from each of the actuator arms 114. Mounted at the distal end of each of the flexures 116 is a transducer or head 118, which includes an air bearing slider enabling the head 118 to fly in close proximity above the corresponding surface of the associated disc 108.

During a seek operation, the track position of the heads 118 is controlled through the use of a voice coil motor 124, which typically includes a coil 126 attached to the actuator assembly 110, as well as one or more permanent magnets 128, which establish a magnetic field in which the coil 126 is immersed. The controlled application of current to the coil 126 causes magnetic interaction between the permanent magnets 128 and the coil 126 so that the coil 126 moves in accordance with the well-known Lorentz relationship. As the coil 126 moves, the actuator assembly 110 pivots about the bearing shaft assembly 112, and the heads 118 are caused to move across the data surfaces of the discs 108.

The spindle motor 106 is typically de-energized when the disc drive 100 is not in use for extended periods of time. The heads 118 are moved over park zones 120 near the inner diameter of the discs 108 when the drive motor is de-energized. The heads 118 are secured over the park zones 120 through the use of an actuator latch arrangement, which prevents inadvertent rotation of the actuator assembly 110 when the heads are parked.

A flex assembly 130 provides the requisite electrical connection paths for the actuator assembly 110 while allowing pivotal movement of the actuator assembly 110 during operation. The flex assembly includes a printed circuit board 132 to which head wires (not shown) are connected; the head wires being routed along the actuator arms 114 and the flexures 116 to the heads 118. The printed circuit board 132 typically includes circuitry for controlling the write currents applied to the heads 118 during a write operation and a preamplifier for amplifying read signals generated by the heads 118 during a read operation. The flex assembly terminates at a flex bracket 134 for communication through the base deck 102 to a disc drive printed circuit board (not shown) mounted to the bottom side of the disc drive 100.

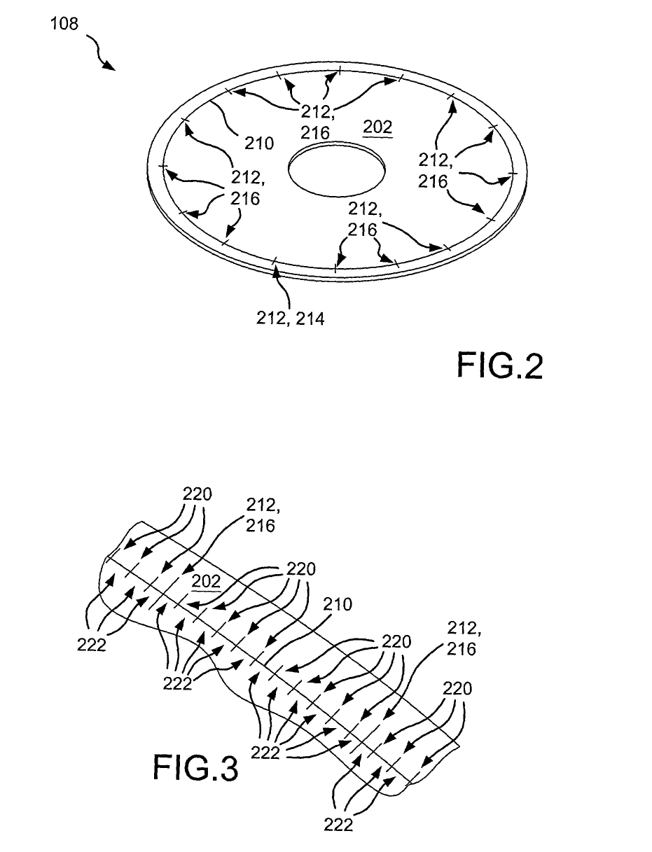

FIG. 2 illustrates a disc 108 having a data surface 202 with a circular track 210 defined thereon. The disc 108 preferably includes many radially spaced concentric tracks, though only one track 210 is illustrated in FIG. 2. The head 118 of FIG. 1 can read the data stored on the track 210 as the head 118 flies over the track 210. The track 210 includes alternating data and servo sectors. The data sectors store information, such as data and binary code. The servo sectors include housekeeping information for the disc drive 100, which is described more fully below.

Rather than having only a single index servo sector, multiple uniquely identifiable index servo sectors 212 are located around the circular track 210. The disc 108 in FIG. 2 includes sixteen index servo sectors 212, which include one main index servo sector 214 and fifteen secondary index servo sectors 216. However, other numbers of index servo sectors 212 may be used so long as they include at least two index servo sectors 212. As with previous index servo sectors, the main index servo sector 214 indicates that the head has traveled a complete revolution of the track 210. Thus, when the head 118 encounters the main index servo sector 214, the servo sector number is reset. However, because each index servo sector 212 is uniquely identifiable, the position of the head 118 over the track 210 can be readily ascertained as soon as the head encounters one of the index servo sectors 212, whether it is the main index servo sector 214 or a secondary servo sector 216. A counter then increments the servo sector number as the head 118 encounters subsequent servo sectors (both index servo sectors and non-index servo sectors) to determine the current angular position of the head on the track 210.

Referring to FIG. 3, two index servo sectors 212 from the disc 108 of FIG. 2 are illustrated. Additionally, non-index servo sectors 220 are interspersed between the index servo sectors 212, and data sectors 222 are interspersed between the servo sectors 212 and 220 around the track 210.

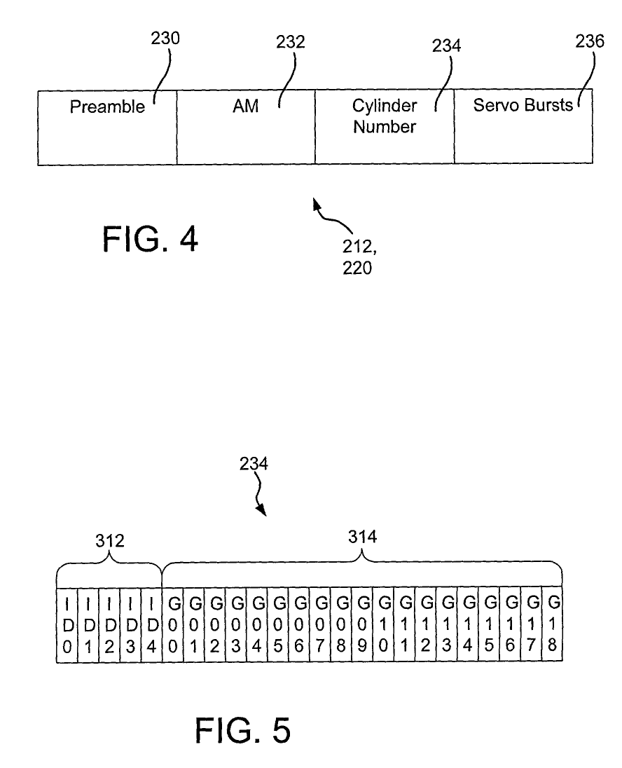

Referring to FIG. 4, each servo sector 212 and 220 preferably includes a preamble 230 that is used to synchronize the disc drive read channel clock with the frequency of the bits on the track 210; an “AM” 232, which is a timing mark; a coded cylinder number 234 that includes a Gray coded cylinder or track identification code as well as any index bits; and servo bursts 236 that are used to calculate the position error signal.

Referring now to FIG. 5, the cylinder number 234 preferably includes both an encoded index value or index code 312 and an encoded cylinder or track identification code 314. Each track identification code 314 is unique to a particular track 210 on a data surface 202, and each index code 312 is unique to a particular index servo sector 212 on a track 210. However, index servo sectors 212 of different tracks 210 can have the same index code 312, and tracks 210 of different data surfaces 202 can have the same track identification code 314. Prior cylinder numbers included an index bit (which was typically “1” for the index servo sector and a “0” for all other sectors) and many bits (for example, sixteen bits) that included the track identification code. Several bits were typically interspersed between the index bit and the track identification code bits. For example, a twenty-four-bit cylinder number could include one index bit, seventeen track identification code bits, and six unused bits. In the embodiment of FIG. 5, the twenty-four-bit cylinder number 234 includes a five-bit index code 312 and a nineteen-bit track identification code 314. By eliminating unused bits from the cylinder number 234, the index servo sectors 212 can include multiple-bit index codes 312 without requiring additional storage space on the track 210 for the cylinder number 234.

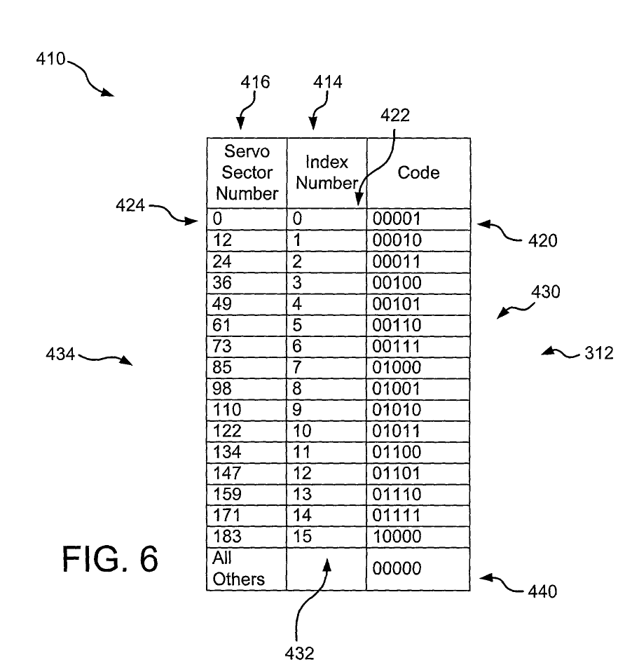

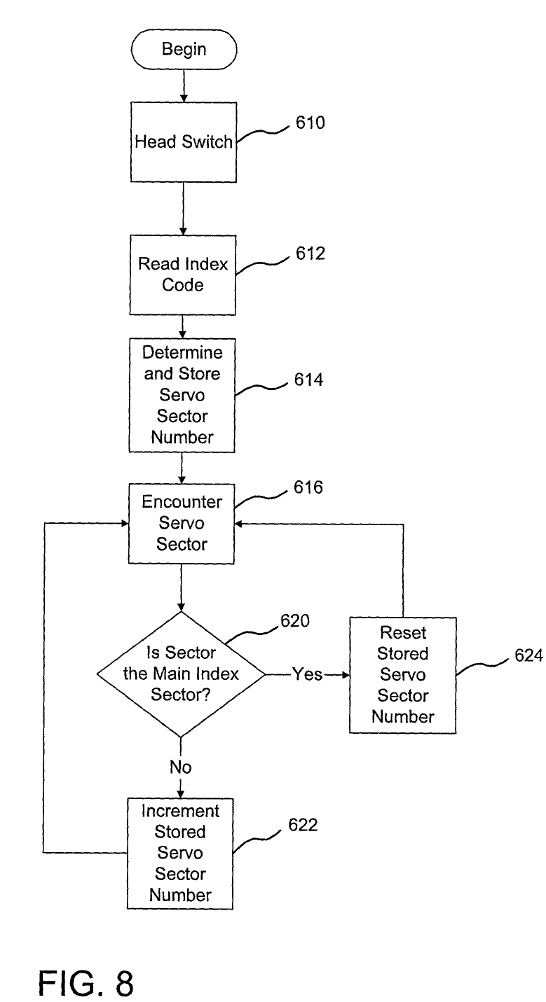

When the head 118 encounters a cylinder number 234, it reads the value of each bit in the cylinder number 234. The disc drive 100 preferably uses a register structure similar to the register structure 410 illustrated in FIG. 6 to unscramble or decode the index code 312. The illustration of register structure 410 depicts an index code 312, an index number 414, and a servo sector number 416 for each index servo sector 212 in a single row. The register structure 410 thus corresponds each index code 312 with an index number 414 and a servo sector number 416. As an example, if the head 118 reads the index code “00011” of a secondary index servo sector 216, the corresponding index number of the index servo sector is “2,” and the corresponding servo sector number of the index servo sector is “24.” Thus, the disc drive 100 can determine the index number 414 and the servo sector number 416 of an index servo sector 212 from the index code 312 of the servo sector. A main index code 420 corresponds to a main index number 422 and a main index sector number 424. Preferably, the main index number 422 and the main index sector number 424 are both “0.” Likewise, each secondary index code 430 corresponds to a secondary index number 432 and a secondary index sector number 434. Additionally, a non-index code 440 corresponds to all non-index servo sectors 220 and thus does not uniquely identify any particular index or servo sector number. Rather, the servo sector numbers of non-index servo sectors 220 are determined in accordance with the process flow described below with reference to FIG. 8.

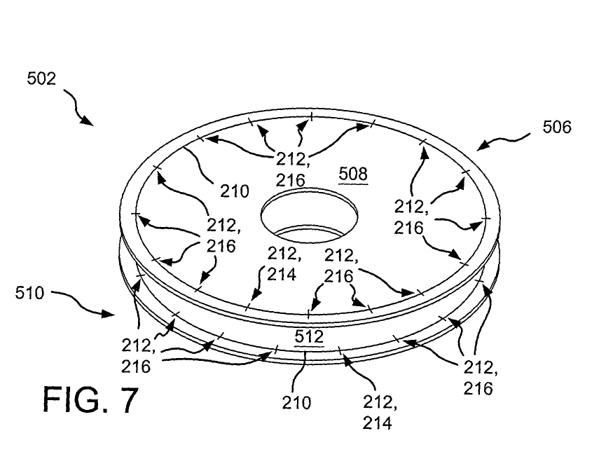

Referring to FIG. 7, two discs of a disc stack 502 are illustrated. A first top disc 506 has a first data surface 508 and a second bottom disc 510 has a second data surface 512. Both data surfaces 508 and 512, and the sectors and tracks defined thereon are preferably the same as the data surface 202 illustrated in FIGS. 2-3 and have the same reference numbers for similar features. Notably, however, the index servo sectors 212 on the first data surface 508 are angularly offset from the index servo sectors 212 on the second data surface 512.

Embodiments of the process flow of the present invention may be implemented either through hardware, i.e., logic devices, or as a computer-readable program storage device which tangibly embodies a program of instructions executable by a disc drive 100 or other computer system for determining a head position over a data surface of a disc during a head switch. As such, the logical operations of the various embodiments of the present invention may be implemented (1) as a sequence of computer implemented acts or program modules running on a computing system and/or (2) as interconnected machine logic circuits or circuit modules within the computing system. The implementation is a matter of choice dependent on the performance requirements of the computing system implementing the invention. Accordingly, the logical operations making up the embodiments of the present invention described herein are referred to variously as operations, structural devices, acts or modules. It will be recognized by one skilled in the art that these operations, structural devices, acts and modules may be implemented in software, in firmware, in special purpose digital logic, and any combination thereof without deviating from the spirit and scope of the present invention as recited within the claims attached hereto.

Prior to a head switch operation being performed, the disc drive 100 operates in a manner similar to prior disc drives, wherein a saved servo sector number is incremented each time the head 118 encounters a servo sector. This incrementing operation continues until the head 118 encounters the main index servo sector 214, at which time the saved servo sector number is reset to the main index sector number 424. After being reset, the saved servo sector number continues to be incremented each time the head 118 encounters a servo sector. This non-head switch operational loop, which is discussed in more detail below, continues until a head switch or some other servo interrupt operation is performed. Referring to FIG. 8, a process flow for determining a head position over a data surface of a disc during a head switch operation is illustrated. In head switch operation 610 a head switch is performed from a head 118 over the first data surface 508 to a head 118 over the second data surface 512. In other words, the disc drive 100 switches from read or write operations on the first data surface 508 to read or write operations on the second data surface 512.

After the head switch operation 610, the angular position of the head 118 over the track 210 of the second data surface 512 may be unknown because the index servo sectors 212 on the first data surface 508 are angularly offset from the index servo sectors 212 on the second data surface 512. However, in read index code operation 612, the head 118 encounters and reads an index code 312 on the track 210 of the second data surface 512, which is preferably the first index code 312 encountered by the head 118 after the head switch operation 610. The encountered index code 312 may be a main index code 420 or a secondary index code 430. In either case, a corresponding servo sector number 416 is determined from the index code 312 and stored in the disc drive 100 in determine servo sector number operation 614. This may be done by decoding or unscrambling the index code 312, such as by using the register structure 410 described above with reference to FIG. 6. This determination locates the angular position of the head 118 over the second data surface 512. Notably, the location of the head 118 is thus determined without requiring the head 118 to encounter the main index servo sector 214, which could require a full revolution of the disc stack 502. Thus, the disc drive 100 need not wait for a full revolution of the disc stack 502 after the head switch operation 610 before engaging in read and write operations on the second data surface 512, even if the index servo sectors 212 on the first data surface 508 are angularly offset by an unknown amount from the index servo sectors 212 on the second data surface 512.

The process flow then enters the non-head switch operational loop discussed above. More specifically, the head 118 encounters another servo sector 212 or 220 in encounter servo sector operation 616. Then, in main index sector query operation 620, the index code 312 or non-index code 440 from the servo sector 212 or 220 is read and the disc drive 100 determines whether the encountered code is the main index code 420. If the encountered code is not the main index code 420, then the disc drive 100 increments the stored servo sector number by one in increment servo sector number operation 622. Thus, if the servo sector number 416 corresponding to the preceding index servo sector 212 is twelve, then the stored servo sector number is incremented to thirteen, revealing that the encountered servo sector 212 or 220 is servo sector number thirteen. If the main index sector query operation 620 determines that the encountered servo sector is the main index servo sector 214, then the disc drive 100 resets the saved servo sector number to the main index sector number 424, which is preferably zero, in reset sector number operation 624. Whether the saved servo sector number is reset in reset sector number operation 624 or incremented in increment servo sector number operation 622, the process returns to the encounter servo sector operation 616 the next time a servo sector 212 or 220 is encountered by the head 118. This non-head switch operational loop, including operations 616, 620, 622, and 624, preferably continues until another head switch operation or some other servo interrupt operation is performed.

An embodiment of the present invention may be summarized as a method of determining a disc drive head position. The method includes switching from a first head (such as 118) to a second head (such as 118). The method also includes reading an index code (such as 312) from one of a plurality of index servo sectors (such as 220) on a second data surface (such as 512) and determining an index servo sector number (such as 424 or 434) from the index code. Additionally, the method includes incrementing the servo sector number as the second head encounters subsequent servo sectors.

Index servo sectors on a first data surface (such as 508) may be angularly offset from the index servo sectors on the second data surface. The index code is preferably scrambled, in which case reading the index code may additionally include unscrambling the index code. In a preferred embodiment, the one of the plurality of index servo sectors includes a track identification code (such as 314) adjacent the index code.

Stated another way, an embodiment of the present invention may be summarized as a method of determining a disc drive head position over a data surface (such as 202, 508, or 512) during a head switch operation. The method includes switching from a first head (such as 118) positioned over a first data surface (such as 508) on one disc (such as 506) to a second head (such as 118) positioned over a second data surface (such as 512) on a different disc (such as 510). Each data surface preferably has non-index servo sectors (such as 220) interspersed between index servo sectors (such as 212) defined thereon. The index servo sectors include a main index servo sector (such as 214) on each data surface and a secondary index servo sector (such as 216) on each data surface. Each index servo sector has a unique index code (such as 312) corresponding to its angular track position, and the index servo sectors on the first data surface are angularly offset from the index servo sectors on the second data surface. The method also includes reading an index code (such as 312) from an index servo sector (such as 212) on the second surface, and determining a servo sector number (such as 424 or 434) from the index code. The method additionally includes incrementing the servo sector number as each subsequent servo sector is encountered by the second head, and resetting the servo sector number to a predetermined value (such as 424) when the second head encounters the main index code. The method may also include incrementing the servo sector number as the second head encounters subsequent servo sectors after resetting the servo sector number.

Stated yet another way, an embodiment of the present invention may be described as a disc drive (such as 100) that includes data storage discs (such as 506 and 510) arranged in a disc stack (such as 502). The disc drive is adapted to ascertain a head position following a head switch between a first head (such as 118) positioned over a first data surface (such as 508) on one disc (such as 506) and a second head (such as 118) positioned over a second data surface (such as 512) on a different disc (such as 510) utilizing a plurality of index servo sectors (such as 212) defined on the second data surface.

It will be clear that the present invention is well adapted to attain the ends and advantages mentioned as well as those inherent therein. While a presently preferred embodiment has been described for purposes of this disclosure, various changes and modifications may be made which are well within the scope of the present invention. For example, different numbers of index servo sectors and non-index servo sectors can be used, depending on the features of the particular disc drive. Numerous other changes may be made which will readily suggest themselves to those skilled in the art and which are encompassed in the spirit of the invention disclosed and as defined in the appended claims.

What is claimed is:

1. A method of determining a disc drive head position comprising steps of:
(a) switching from a first head to a second head;
(b) reading an index code from a one of a plurality of index servo sectors on a second data surface;
(c) determining an index servo sector number from the index code; and
(d) incrementing the servo sector number as the second head encounters subsequent servo sectors.

2. The method of claim 1, wherein the index servo sectors on a first data surface are angularly offset from the index servo sectors on the second data surface.

3. The method of claim 1, wherein the index code is scrambled.

4. The method of claim 3, wherein the reading step (b) further comprises unscrambling the index code.

5. The method of claim 1, wherein the one of the plurality of index servo sectors further comprises a track identification code adjacent the index code.

6. A method of determining a disc drive head position over a data surface during a head switch operation between a first head positioned over a first data surface on one disc and a second head positioned over a second data surface on a different disc, wherein each data surface has non-index servo sectors interspersed between index servo sectors defined thereon, the index servo sectors including a main index servo sector on each data surface and a secondary index servo sector on each data surface, each index servo sector having a unique index code corresponding to its angular track position, the index servo sectors on the first data surface being angularly offset from the index servo sectors on the second data surface, the method comprising steps of:
(a) switching from the first head to the second head;
(b) reading an index code from an index servo sector on the second surface;
(c) determining a servo sector number from the index code;
(d) incrementing the servo sector number as each subsequent servo sector is encountered by the second head; and
(e) resetting the servo sector number to a predetermined value when the second head encounters the main index code.

7. The method of claim 6, further comprising a step of:
(f) incrementing the servo sector number as the second head encounters subsequent servo sectors after resetting the servo sector number in step (e).

8. The method of claim 6, wherein the index codes are scrambled codes.

9. The method of claim 8, wherein the reading step (b) further comprises unscrambling the index code.

10. The method of claim 9, wherein the index servo sectors each further comprise a track identification code adjacent the index code.

11. A disc drive comprising:
a plurality of data storage discs arranged in a disc stack, the disc drive adapted to ascertain head position following a head switch between a first head positioned over a first data surface on one disc and a second head positioned over a second data surface on a different disc utilizing a plurality of index servo sectors defined on the second data surface.

12. The disc drive of claim 11, wherein the disc drive is further adapted to:
switching from the first head to the second head;
reading an index code from an index servo sector on the second data surface;
determining an index servo sector number from the index code; and
incrementing the index servo sector number as the second head encounters subsequent servo sectors.

13. The disc drive of claim 12, wherein the index code is scrambled.

14. The disc drive of claim 13, wherein the disc drive is further adapted to unscramble the index code.

15. The disc drive of claim 11, further comprising non-index servo sectors interspersed between the index servo sectors on the second data surface.

16. The disc drive of claim 11, wherein the first data surface defines a plurality of index servo sectors thereon and the index servo sectors on the first data surface are angularly offset from the index servo sectors on the second data surface.
